(19) United States
(12) Patent Application Publication
(10) Pub. No.: US 2023/0296485 A1
(43) Pub. Date: Sep. 21, 2023

(54) PATHOGEN COLLECTION AND HANDLING SYSTEM

(71) Applicant: University of Maine System Board of Trustees, Orono, ME (US)

(72) Inventors: Caitlin Howell, Orono, ME (US); Daniel Regan, Washington, DC (US)

(21) Appl. No.: 18/013,938

(22) PCT Filed: Jun. 30, 2021
(86) PCT No.: PCT/US2021/039956

§ 371 Date: Dec. 30, 2022

Related U.S. Application Data
(60) Provisional application No. 63/046,671, filed on Jun. 30, 2020.

(51) Int. Cl. G01N 1/40; B01D 61/38; B01D 71/52; B01D 67/00

(52) U.S. Cl. CPC G01N 1/4005; B01D 61/38; B01D 71/52; B01D 67/0088

(57) ABSTRACT

The present disclosure provides, inter alia, systems and methods for the capture and retrieval of pathogens and/or other analytes of interest (e.g., aerosolized pathogens or other analytes).

### CROSS REFERENCE TO RELATED APPLICATIONS

This application claims the benefit of U.S. Provisional Application No. 63/046,671, filed Jun. 30, 2020, the contents of which is hereby incorporated by reference herein.

### BACKGROUND

Opportunistic organisms that infect the airway or open wounds pose many complications to the medical treatment of patients, especially those that are multidrug-resistant. High-efficiency particulate air (HEPA) and HEPA like filters trap particulates within filter on substrate's fibers and have been used in hospital buildings to attempt to reduce nosocomial infections. However, these filters do not release the captured pathogens to allow medical personnel to analyze the pathogens present (Kelly-Wintenberg et al., 2000 and Kowalski et al., 1999).

### SUMMARY

The spreading of biological pathogens via aerosolized droplets has been a major concern during the COVID-19 pandemic. Thus, the ability to capture and analyze aerosolized pathogens is of critical importance to understanding the potential of reoccurring outbreaks of COVID-19 or other novel biothreats. The present invention, includes, among other things, a bioinspired technology that facilitates the efficient collection of viruses from, inter alia, bioaerosols, herein referred to as “Liquid Nets” that can capture pathogens and release them for analysis due to the use of a capture liquid on filter fibers/surfaces.

The present disclosure encompasses the recognition that, by engineering a composite material comprised of a liquid layer on the surface of a membrane, the capture and analysis of pathogenic particles can be facilitated. As used herein, the terms “capture liquid”, “liquid coating”, “overlayer”, “liquid layer” and “infusing liquid” are all terms that refer to the liquid associated with the membrane/substrate of the described Liquid Nets.

Disclosed embodiments are related, inter alia, to high-throughput systems for capturing delicate particulates, particularly pathogens, in fluids and delivering them intact for analysis. The present invention is designed, for example, to work with SARS-CoV-2, the virus responsible for the COVID-19 outbreak, in aerosolized droplets that mimic those released during talking, coughing, and sneezing. The present disclosure provides, among other things, systems to facilitate monitoring the spread of disease using an inexpensive, high-throughput, and widely deployable technology to capture and release pathogens for analysis that can be continuously operated at high-risk locations, such as hospitals, elder-care facilities, and travel hubs.

Among other things, in some embodiments, the present disclosure provides systems and methods for capturing and releasing for analysis pathogen/analyte in a fluid sample (e.g., an aerosolized pathogen in the air). In accordance with various embodiments, a system can be designed such that a pathogen/analyte of interest is collected and remains intact so that it can be analyzed.

### BRIEF DESCRIPTION OF THE DRAWING

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows an illustration of parameters investigated for optimization of certain embodiments, including viscosity, recovery time, filter pore size, and capture liquid layer thickness.

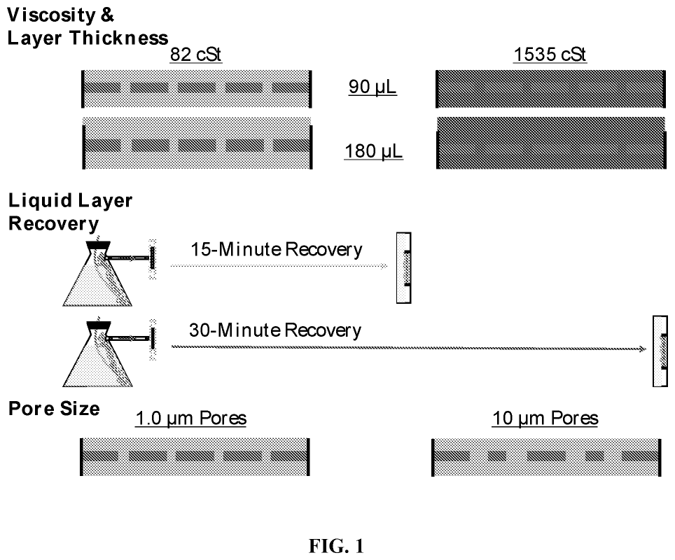

FIG. 2 shows colony forming unit (CFU) counts of E. coli GFP captured by Liquid Nets made on one-micron filters after 15 (gray) and 30 (navy) minute recovery periods. Treatments include the bare filter (control) low-volume low-viscosity, low-volume high-viscosity, high-volume low-viscosity, and high-volume high-viscosity Liquid Nets (from left to right).

FIG. 3 Panel A shows an exemplary configuration of a Liquid Net that is configured as an in-line addition to an air purification device. Briefly, (i) an air purifier [300] with an intake area [301] is covered with (ii) a Liquid Net either directly attached or as a separate insert. The Liquid Net includes a support structure [302] and the active surface [303]. The (iii) active surface itself consists of [304] the fibers/solid material supporting the liquid and [306] the liquid itself. In some embodiments, there are spaces [305] between the liquid-coated fibers. FIG. 3 Panel B diagrams the functioning and process of sample collection/removal from Liquid Nets disclosed herein. (i) An aerosol containing particulates of interest [307] is exposed to a Liquid Net consisting of a solid substrate [304] and a liquid coating (seen in cross section) [306]. (ii) When the aerosol is pulled across the membrane and through the pores [305], some of the particulates become associated with the liquid surface. (iii) When the filtration stops, in some embodiments, the liquid may assist in pushing the particulates of interest outward/upward as the liquid re-equilibrates. To collect or remove the particulates from the surface, a variety of methods can be used, including (but not limited to) (iv) the use of a collection liquid that is immiscible with the Liquid Net coating liquid [308], e.g., water, which passes over the coating liquid and either solubilizes the particulates or removes the top layer of the coating liquid, (v) the removal of all or a substantial amount of the coating liquid, and the particulates along with it, via a compatible solute [309], or (vi) the mechanical removal of the top portion of the coating liquid along with the particulates contained therein [310].

FIG. 4 shows a schematic of the front views of three different configurations of a capture liquid [401] coating the pores mesh and/or surface of a filter or membrane [402], with or without leaving open pores [400] in between the coated fibers, according to some embodiments. Panel A shows the top view of two examples of a configuration where there are pores in between the coated fibers. Panel B shows a top view of a configuration where there are not open pores between the coated fibers (left) as well as one side view (right) of a mesh/filter/membrane section with the coating liquid on both sides (i.e., both the “active” side and the “chamber” side). All of these schematics are for systems that are not under pressure, i.e., not actively filtering.

FIG. 5 depicts two different modes of action of the capture liquid on the membrane, represented in cross-section. Panel A shows (i) the capture liquid [500] initially filling or almost filling the pores or gaps [501] between the solid mesh/filter/membrane material [502]. When pressure is applied across the membrane (ii), filtration begins and target particles [503] are captured in/on the liquid. When pressure is released (iii), the liquid re-equilibrates, which may force the target particles toward the membrane surface [504] (active side). In Panel B, the same process of (i) initial status, (ii) filtration/particle capture, and (iii) resting occurs but with more space between the capture liquid layer in the pores. In this embodiment, the increasing diameter of the pore due to the retraction of the capture liquid in the pores upon the application of pressure, followed by the decreasing diameter of the pore due to the advancement of the capture liquid when pressure is released, contributes to the movement of the target particles to the surface. In (iv), the target particles are shown being removed from the capture liquid surface via a second liquid [505] that is immiscible with the capture liquid but chemically compatible with the target particles (e.g. water), in one embodiment.

FIG. 6 describes several possible interactions of the target particles [600] with the capture liquid [601]. Panel A shows examples in which the target can be embedded in the liquid either as a single particle [602] or a group of particles [603], or situated on top of the capture liquid either with [604] or without [605] a cloaking/wrapping layer of capture liquid over the particle. Panel B shows how the arrangement of particles within the liquid may change as the system approaches equilibrium after filtration in some embodiments: (i) shows the particles assembling at the capture liquid/filtration fluid interface during filtration. When pressure is released, (ii) shows the target particles moving close to the surface, while (iii) shows the particles equilibrating but remaining embedded within the liquid.

FIG. 7 shows data on the effectiveness of one embodiment of a Liquid Net device and method described herein at capturing aerosolized Escherichia coli K12 (GFP expressing) in phosphate-buffered saline droplets. Panel A shows an example set of data describing how the calculation was made; namely, that the number of E. coli colony-forming units (CFUs) is normalized by dividing the CFU number obtained from the nth pass of a mechanical collection (stamping) by the number obtained from the first pass, hereafter referred to as “R-value”. A filter surface that releases the same number of bacteria at each pass/stamp yields a straight line, while a filter that allows for more removal with fewer passes shows an exponential decrease. This metric was adopted to minimize the natural variation present in aerosolized bacterial cultures. Panel B shows the data from a PTFE membrane either uncoated (control) or coated with 80 μl of Krytox 103 (80 K103) or 80 μl of more viscous Krytox 107 (80 K107). Panel C shows the same data, only with a thicker layer of capture liquid: 160 μl of Krytox 103 (160 K103) or 160 μl of Krytox 107 (160 K107).

FIG. 8 shows an example experimental setup used to test Liquid Nets described herein, both a photo (Panel A) and a process-flow diagram (Panel B).

FIG. 9 shows an illustration of exemplary parameters investigated for systems described herein in further experiments. Panel A shows exemplary pore sizes that were tested. Panel B shows exemplary viscosity and layer thickness testing parameters. Panel C shows liquid layer recovery times after exposure to aerosolized bacteria (including 0 recovery, 15 minute recovery, and 30 minute recovery). Panel D shows a schematic of the mechanical removal or stamping process used to generate the data in FIG. 7, panels B and C.

FIG. 10 shows exemplary data regarding the rate of bacterial cell retrieval using Liquid Nets with 1.0 μm pores for various recovery times, or periods of rest which allow the liquid coating to re-equilibrate. Rate of bacterial retrieval measures effectiveness of the membrane in transferring the captured target particle (here, E. coli CFUs) after the first pass of mechanical liquid removal or “stamp”, as illustrated in FIG. 9, panel D, and calculated as illustrated in FIG. 7, panel A. The groups tested include an uncoated “control”, “80K103” (80 μl of lower-viscosity Kyrtox 103 capture liquid—a type of perfluoropolyether), “80K107” (80 μl of higher-viscosity Krytox liquid), “160K103” (160 μl of Krytox 103), and “160K107” (160 μl of Krytox 107). Panel A shows the rate of bacterial release after a 0-minute recovery. Panel B shows the rate of bacterial release after a 15-minute recovery. Panel C shows the rate of bacterial release after a 30-minute recovery.

FIG. 11 shows exemplary data showing the amount of CFUs of E. coli that were transferred after first pass of mechanical removal/stamp, as illustrated in FIG. 9 and calculated as shown in FIG. 7, panel A, using Liquid Nets with 1.0 μm pores for 0-minute recovery (Panel A), 15-minute recovery (Panel B), and a 30-minute recovery (Panel C). The groups tested include an uncoated “control”, “80K103” (80 μl of lower-viscosity Kyrtox 103 capture liquid), “80K107” (80 μl of higher-viscosity Krytox 107 liquid), “160K103” (160 μl of Krytox 103), and “160K107” (160 μl of Krytox 107).

FIG. 12 shows exemplary data regarding the rate of bacterial cell retrieval using Liquid Nets with 10.0 μm pores for various recovery times. Rate of bacterial retrieval measures effectiveness of the membrane in transferring the captured target particle (here, E. coli CFUs) after the first pass of mechanical liquid removal or “stamp”, as illustrated in FIG. 9, panel D, and calculated as illustrated in FIG. 7, panel A. The groups tested include an uncoated “control”, “40K103” (40 μl of lower-viscosity Kyrtox 103 capture liquid), “40K107” (40 μl of higher-viscosity Krytox 107 liquid), “80K103” (80 μl of Krytox 103), “80K107” (80 μl of Krytox 107). Panel A shows the rate of bacterial cell retrieval after a 15-minute recovery. Panel B shows the rate of bacterial release after a 30-minute recovery.

FIG. 13 shows the amount of CFUs of E. coli that were transferred after first stamp using Liquid Nets with 10.0 μm pores for 15-minute recovery (Panel A), and 30-minute recovery (Panel B). The groups tested include an uncoated “control”, “40K103” (40 μl of Krytox 103 capture liquid), “40K107” (40 μl of Krytox 107), “80K103” (80 μl of Krytox 103), and “80K107” (80 μl of Krytox 107).

FIG. 14 shows exemplary data regarding the rate of bacterial cell retrieval using Liquid Nets made using PFPE capture liquids (Krytox) on commercially-available HEPA filters. Rate of bacterial retrieval measures effectiveness of the membrane in transferring the captured target particle (here, E. coli CFUs) after the first pass of mechanical liquid removal or “stamp”, as illustrated in FIG. 9, panel D, and calculated as illustrated in FIG. 7, panel A. The groups tested include an uncoated “control” and “160K103” (160 μl of Krytox 103) with three independent replicates 3, 2, and 1 shown. Data from two separate trials are shown in FIG. 14, panels A and B.

FIG. 15 shows exemplary data regarding the amount of CFUs of E. coli that were transferred after first stamp using Liquid Nets made using PFPE capture liquids (Krytox) on commercially-available HEPA filters. The groups tested include an uncoated “control” and “160HEPA” (160 μl of Krytox). Data from two separate trials are shown in FIG. 15, panels A and B.

### DEFINITIONS

In order for the present invention to be more readily understood, certain terms are first defined below. Additional definitions for the following terms and other terms are set forth throughout the specification. The publications and other reference materials referenced herein to describe the background of the invention and to provide additional detail regarding its practice are hereby incorporated by reference.

Approximately or about: As used herein, the term “approximately” or “about,” as applied to one or more values of interest, refers to a value that is similar to a stated reference value. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Biological Sample: As used herein, the term “biological sample” refers to a sample obtained or derived from a biological source (e.g., a tissue or organism or cell culture) of interest, as described herein. In some embodiments, a source of interest comprises an organism, such as an animal or human. In some embodiments, a biological sample is or comprises biological tissue or fluid. In some embodiments, a biological sample may be or comprise blood; blood cells; ascites; tissue or fine needle biopsy samples; cell-containing body fluids; free floating nucleic acids; sputum; saliva; urine; pleural fluid; lymph aspirates; other body fluids, secretions, and/or excretions; and/or cells therefrom, etc. In some embodiments, a biological sample is or comprises cells obtained from an individual. In some embodiments, obtained cells are or include cells from an individual from whom the sample is obtained. In some embodiments, a sample is a “primary sample” obtained directly from a source of interest by any appropriate means. For example, in some embodiments, a primary biological sample is obtained by methods of collection of body fluid (e.g., blood, lymph, etc.), etc. In some embodiments, as will be clear from context, the term “sample” refers to a preparation that is obtained by processing (e.g., by removing one or more components of and/or by adding one or more agents to) a primary sample. For example, filtering using a semi-permeable membrane. Such a “processed sample” may comprise, for example nucleic acids or proteins extracted from a sample or obtained by subjecting a primary sample to techniques such as amplification or reverse transcription of mRNA, isolation and/or purification of certain components, etc.

Biomarker: The term “biomarker” is used herein, consistent with its use in the art, to refer to a to an entity, event, or characteristic whose presence, level, degree, type, and/or form, correlates with a particular biological event or state of interest, so that it is considered to be a “marker” of that event or state. To give but a few examples, in some embodiments, a biomarker may be or comprise a marker for a particular disease state, or for likelihood that a particular disease, disorder or condition may develop, occur, or reoccur. In some embodiments, a biomarker may be or comprise a marker for a particular disease or therapeutic outcome, or likelihood thereof. Thus, in some embodiments, a biomarker is predictive, in some embodiments, a biomarker is prognostic, in some embodiments, a biomarker is diagnostic, of the relevant biological event or state of interest. A biomarker may be or comprise an entity of any chemical class, and may be or comprise a combination of entities. For example, in some embodiments, a biomarker may be or comprise a nucleic acid, a polypeptide, a lipid, a carbohydrate, a small molecule, an inorganic agent (e.g., a metal or ion), or a combination thereof. In some embodiments, a biomarker is a cell surface marker. In some embodiments, a biomarker is intracellular. In some embodiments, a biomarker is detected outside of cells (e.g., is secreted or is otherwise generated or present outside of cells, e.g., in a body fluid such as blood, urine, tears, saliva, cerebrospinal fluid, etc. In some embodiments, a biomarker may be or comprise a genetic or epigenetic signature. In some embodiments, a biomarker may be or comprise a gene expression signature.

Improve, increase, or reduce: As used herein, the terms “improve,” “increase” or “reduce,” or grammatical equivalents, indicate values that are relative to a baseline measurement, such as a measurement in the same sample prior to initiation of a treatment or process step described herein, or a measurement in a control sample (or multiple control samples) in the absence of a treatment or process step described herein.

Porosity: The term “porosity” as used herein, refers to a measure of void spaces in a material and is a fraction of volume of voids over the total volume, as a percentage between 0 and 100%. A determination of porosity is known to a skilled artisan using standardized techniques, for example mercury porosimetry and gas adsorption (e.g., nitrogen adsorption).

Sample: As used herein, the term “sample” typically refers to an aliquot of material obtained or derived from a source of interest, as described herein. In some embodiments, a source of interest is a biological or environmental source. In some embodiments, a sample is a fluid. In some embodiments, a sample is a gas. In some embodiments, a sample is an air sample. In some embodiments, a source of interest may be or comprise a cell or an organism, such as a microbe, a plant, or an animal (e.g., a human). In some embodiments, a source of interest is or comprises biological tissue or fluid. In some embodiments, a biological tissue or fluid may be or comprise aqueous humor, ascites, blood, mucus, pus, rheum, saliva, sebum, sweat, tears, urine, vomit, and/or combinations or component(s) thereof. In some embodiments, a biological fluid may be or comprise an intracellular fluid, an extracellular fluid, an intravascular fluid (blood plasma), an interstitial fluid, and/or a transcellular fluid In some embodiments, a biological tissue or sample may be obtained, for example, washing or lavage (e.g., brocheoalvealar, ductal, nasal, ocular, oral, uterine, vaginal, or other washing or lavage). In some embodiments, a biological sample is or comprises cells obtained from an individual. In some embodiments, a sample is a “primary sample” obtained directly from a source of interest by any appropriate means. In some embodiments, as will be clear from context, the term “sample” refers to a preparation that is obtained by processing (e.g., by removing one or more components of and/or by adding one or more agents to) a primary sample. For example, filtering using a semi-permeable membrane. Such a “processed sample” may comprise, for example nucleic acids or proteins extracted from a sample or obtained by subjecting a primary sample to one or more techniques such as amplification or reverse transcription of nucleic acid, isolation and/or purification of certain components, etc.

Substantially: As used herein, the term “substantially” refers to the qualitative condition of exhibiting total or near-total extent or degree of a characteristic or property of interest. One of ordinary skill in the chemical arts will understand that biological and chemical phenomena rarely, if ever, go to completion and/or proceed to completeness or achieve or avoid an absolute result. The term “substantially” is therefore used herein to capture the potential lack of completeness inherent in many biological and chemical phenomena.

### DETAILED DESCRIPTION OF CERTAIN EMBODIMENTS

Disease-causing agents such as the novel coronavirus (SARS-CoV-2) that take form as bioaerosols present unique challenges for disease surveillance, containment, and treatment. Previous attempts to design aerosol collection systems for viruses have had limited success due, in many cases, to the difficulty of retrieving intact virus particles from a solid filter surface and/or to their inadequate throughput.

The most recent breakout of the Coronavirus, in addition influenza, Zika, and Ebola⁵ continue to demonstrate the stress put on a healthcare network when the disease is poorly monitored. Another trend within the scientific community is the alarming rate at which multidrug-resistant pathogens are occurring and straining the treatment options for their victims (Manner et al, 2012). Opportunistic organisms that infect the airway or open wounds pose many complications to the medical treatment of patients, especially those that are multidrug-resistant. These trends have led researchers to focus on minimizing the risk of nosocomial, or hospital-acquired, infections (Edelsberg et al., 2014 and Fronczek et al., 2015). While HEPA (high efficiency particulate air) filters have been used in hospital buildings to attempt to reduce nosocomial infections, they do not release the captured pathogens to allow medical personnel to analyze the pathogens present and prepare a more informed course of medical care for exposed patients.

Understanding where airborne infectious or hazardous materials are and at what quantities can be a critical part of slowing the spread of infection and disease. However, airborne or waterborne particulates, particularly those containing infectious pathogens such as viruses and bacteria, can be challenging to capture in a way which preserves the original structure and function of the active materials they contain. For example, high-efficiency particulate air (HEPA) and HEPA-like filters trap particulates within the substrate's fibers and have been used in hospital buildings to attempt to reduce the spread of infectious agents. However, these filters are not designed to permit easy removal of pathogens from the filters, making it difficult if not impossible to test any captured agents post hoc for their ability to proliferate and/or infect a host (Kelly-Wintenberg et al., 2000 and Kowalski et al., 1999).

Some solutions to this problem have been devised, such as condensation particle growth capture systems, swirling aerosol collectors, cyclone samplers, 3-piece filter cassettes, slit samplers, Andersen samplers, and liquid impingers (Verreault et al., 2008). Yet all of these methods rely on forcing a single stream of fluid, almost always air, through a small opening, limiting their ability to sample large volumes of fluid in short amounts of time. The COVID-19 pandemic has resulted in a heightened awareness of the need for high-throughput filtration systems that permit easy collection and analysis of active particulates such as viruses or other novel biothreats.

Where HEPA filters are designed to trap pathogens within the system, liquid-gated membranes have filtered both organic and inorganic matter while being able to remove the residue of blocked particulates (Hou et al., 2015; Overton et al., 2017; Alvarenga et al., 2018). Much like liquid-infused surfaces (Howell et al., 2018; Regan et al., 2019; Regan et al., Biointerphases 2019), liquid-gated membranes maintain a liquid overlayer that is stabilized from the chemical affinity between the infusing liquid and the chemical structure of the base membrane (Hou et al., 2015 and Aizenberg et al., 2018). Importantly, liquid-gated membranes have pores that can be opened and then fully re-close upon release of pressure. Studies have shown their ability to reduce fouling of traditional membrane filters (e.g., the buildup of contaminants and the release rhodamine dye (Hou et al., 2015), nanoclay particles (Alvarenga et al., 2018), whey protein (Overton et al., 2017), and biofilms of S. epidermidis (Overton et al., 2017).

Liquid layers on solid substrates (i.e., liquid gated-membranes) have recently gathered attention as a new approach to anti-fouling surface treatments (Wong et al., 2011), with particular efficacy against biological materials (Howell et al., 2018; Regan et al., Biointerphases 2019; Aizenberg et al., 2018; Howell et al., 2014; Sotiri et al., 2016; Kovalenko et al., 2017; Sotiri et al., 2018). However, these layers have almost exclusively been used to resist adhesion by materials (Aizenberg et al., 2016; Aizenberg et al., 2018; Aizenberg et al., 2018). For example, Slippery Liquid Infused Porous Surfaces (SLIPS) (Aizenberg U.S. Pat. No. 9,353,646B2) were developed to “repel a wide range of materials”, while Liquid-Gated Membranes (Aizenberg U.S. Ser. No. 10/330,218) rely on the presence of a contiguous liquid coating across the membrane surface and pores which open and close in response to pressure to create a non-fouling surface. Another approach to creating liquid layers on solid substrates involves trapping the liquid within surface structures (Varanasi U.S. Pat. No. 8,574,704B2), also with the intention of creating a “non-wetting and low-adhesion” surface. Critically, in all three of these cases, the liquid layer is also expected to remain associated with the surface, rather than be removed. The present disclosure, however, demonstrates for the first time, a system capable of capturing target particles from fluid streams in a way that permits their easy retrieval via removal of the liquid layer itself.

The present disclosure provides, among other things, a bioinspired technology that facilitates efficient large-volume filtration and collection of viruses from, inter alia, bioaerosols. In accordance with various embodiments, systems and methods encompassed by the present disclosure allow for the identification, detection, and/or retrieval of pathogens/analytes.

In certain embodiments, the system employs a water-immiscible liquid on the surface of the membrane that creates a reusable, reversible liquid trap that immobilizes live pathogenic particles within a thin liquid shell at the surface of the membrane. In some embodiments, systems and methods of the present invention allow for the collection of intact pathogens that can be further analyzed and characterized, e.g., by reverse transcription-quantitative PCR, infectivity assays, and structural assessment.

The present disclosure encompasses the recognition that, by engineering a composite material which comprises a layer of capture liquid (i.e., liquid coating) on the surface of a membrane or mesh (i.e., “active side” or “environment side”), the capture and easy removal of pathogenic particles can be facilitated with minimal damage to the particles. In some embodiments, systems and methods of the present disclosure encompass use of a liquid coating on a substrate/membrane to capture airborne particulates, where the structure and viability of the particulates (e.g. viral infectivity) is preserved. Use of a liquid layer as a protective coating on particulates maintains hydration and prevent viability and/or structural changes due to desiccation. This present system traps particles of interest (e.g., microbial particles such as bacteria or viruses, toxins, spores, chemicals, drugs, and combinations thereof), on liquid layer near the surface of the liquid net (e.g., an active surface of the membrane/substrate). Additionally, in some embodiments, systems of the present disclosure demonstrate the use of a liquid coating (e.g., an overlayer) that can be used transfer captured particulates (e.g., pathogens/analytes) to a new medium.

### Uses

The systems and methods of the present disclosure, include, e.g., the capture and release of organic and/or inorganic matter from fluid-borne environments (e.g., airborne environments, water or other liquid-borne environments).

In some embodiments, the system and methods of the present disclosure are used to collect pathogens/analytes onboard spacecraft like the ISS or military vehicle such as emergency medical transports. In some embodiments, systems and methods of the present disclosure are used in high-traffic areas (e.g., civilian areas).

The present disclosure provides, among other things, systems and methods of monitoring the spread of disease using an inexpensive, high-throughput, and widely deployable technology that can be continuously operated at high-risk locations, such as hospitals, elder-care facilities, and travel hubs.

In some embodiments, the system and methods of the present disclosure are used to capture and deliver aerosolized droplets containing SARS-CoV-2, the virus responsible for the COVID-19 outbreak released during talking, coughing, and sneezing. In accordance with various embodiments, a system can be designed such that a pathogen/analyte of interest is collected and remains intact so that it can be analyzed.

Environments

In some embodiments, organic/inorganic matter is or comprises one or more pathogen(s)/analyte(s). In some embodiments, a pathogen/analyte is or comprises bacteria, virus, spore, and/or other pathogen that can be damaged or rendered inactive through traditional filtration.

In some embodiments, systems and methods of the present disclosure can be used to detect pathogens (e.g., fluid borne pathogens such as airborne or waterborne pathogens) in military operations, healthcare facilities (e.g., surgical suites), medical transportation, mass transportation, areas of mass gatherings, water treatment facilities, and any setting in which user wishes to capture pathogens and particulates while maintaining viability for identification.

In some embodiments, systems and methods of the present disclosure can be used to detect pathogens (e.g., fluid borne pathogens such as airborne or waterborne pathogens) in space (e.g., on the International Space Station). A multitude of bacterial species have contaminated the ISS, despite clean-room manufacturing and decontamination of payloads (Taylor 2015). The presence of bacteria pathogens onboard spacecraft is troubling because studies have shown that the effects of space not only enhance biofilm formation but the mutation rate is increased (Rosenweig et al., 2010 and Fajardo-cavazos et al., 2016). The ISS is currently not fitted with any equipment to collect and preserve airborne samples for monitoring levels of opportunistic pathogens that could be rapidly mutating and developing antibiotic resistance (Mermel 2013).

In some embodiments, a fluid sample is obtained from high-risk locations, such as hospitals, elder-care facilities, and travel hubs.

Analytes/Pathogens

In accordance with various embodiments, any of a variety of pathogens and/or analytes can be detected, identified, and/or collected. For example, in some embodiments, an analyte/pathogen is found in a non-liquid environment or sample. In some embodiments, an analyte/pathogen is aerosolized (e.g., in a liquid droplet suspended in air or another gas). In some embodiments, an analyte/pathogen can be any airborne pathogen.

In some embodiments, an analyte/pathogen is or comprises pathogenic virus (including a virulence factor), pathogenic bacteria, pathogenic fungi, and/or pathogenic protozoa.

Types of analytes/pathogens include e.g., enzymes, immunologic mediators, nucleic acids, proteins, glycoproteins, lipopolysaccharides, protein adducts, tumor and cardiac markers, and/or low-molecular weight compounds, including, but not limited to, haptens, viruses or microorganisms, such as bacteria, fungi (e.g. yeast or molds) or parasites (e.g. amoebae or nematodes), immune mediators such as antibodies, growth factors, complement, cytokines, lymphokines, chemokines, interferons and interferon derivatives, C-reactive protein, calcitonin, amyloid, adhesion molecules, antibodies, and chemo-attractant components, drug molecules such as heroin or methamphetamine, and allergens.

In some embodiments, an analyte/pathogen includes bacteria, a virus, a toxin, a spore, a chemical, a drug, or a combination thereof. In some embodiments, an analyte/pathogen is between about 100 μm and about 10 nm in size (e.g., 20 nm to 100 μm, 50 nm to 100 μm, 100 nm to 100 μm, 200 nm to 100 μm, 300 nm to 100 μm, 400 nm to 100 μm, 500 nm to 10 μm, 600 nm to 10 μm, 700 nm to 1.0 μm, 800 nm to 1.0 μm, 900 nm to 1.0 μm, 1.0 μm to 10 μm). In some embodiments, an analyte/pathogen is about 1.0 μm in size (e.g., a bacteria). In some embodiments, an analyte/pathogen is about 150 nm in size (e.g., a virus). In some embodiments, an analyte/pathogen is at most 100 mm in size. In some embodiments, an analyte/pathogen is at most 100 μm in size. In some embodiments, an analyte/pathogen is at most 10 μm in size. In some embodiments, an analyte/pathogen is at most 1.0 μm in size. In some embodiments, an analyte/pathogen is at most 100 nm in size. In some embodiments, an analyte/pathogen is at most 10 nm in size. In some embodiments, an analyte/pathogen is at most 1.0 nm in size.

In some embodiments, the analyte/pathogen comprises bacteria. Examples of bacteria include E. coli GFP, S. aureus, and P. aeruginosa, Fusobacterium necrophorum (including e.g. one of its subspecies F. necrophorum subsp. necrophorum and F. necrophorum subsp. Funduliforme), Mannheimia (Pasteurella) haemolytica, Actinobacillus actinomycetemcomitans, P. haemolytica, A. actinomycetemcomitans, Examples of bacterial pathogens include bacteria from the following genera and species: Chlamydia (e.g., Chlamydia pneumoniae, Chlamydia psittaci, Chlamydia trachomatis), Legionella (e.g., Legionella pneumophila), Listeria (e.g., Listeria monocytogenes), Rickettsia (e.g., R. australis, R. rickettsia, R. akari, R. conorii, R. sibirica, R. japonica, R. africae, R. typhi, R. prowazekii), Actinobacter (e.g., Actinobacter baumannii), Bordetella (e.g., Bordetella pertussis), Bacillus (e.g., Bacillus anthracis, Bacillus cereus), Bacteroides (e.g., Bacteroides fragilis), Bartonella (e.g., Bartonella henselae), Borrelia (e.g., Borrelia burgdorferi), Brucella (e.g., Brucella abortus, Brucella canis, Brucella melitensis, Brucella suis), Campylobacter (e.g., Campylobacter jejuni), Clostridium (e.g., Clostridium botulinum, Clostridium difficile, Clostridium perfringens, Clostridium tetani), Corynebacterium (e.g., Corynebacterium diphtheriae, Corynebacterium amycolatum), Enterococcus (e.g., Enterococcus faecalis, Enterococcus faecium), Escherichia (e.g., Escherichia coli), Francisella (e.g., Francisella tularensis), Haemophilus (e.g., Haemophilus influenzae), Helicobacter (e.g., Helicobacter pylori), Klebsiella (e.g., Klebsiella pneumoniae), Leptospira (e.g., Leptospira interrogans), Mycobacteria (e.g., Mycobacterium leprae, Mycobacterium tuberculosis), Mycoplasma (e.g., Mycoplasma pneumoniae), Neisseria (e.g., Neisseria gonorrhoeae, Neisseria meningitidis), Pseudomonas (e.g., Pseudomonas aeruginosa), Salmonella (e.g., Salmonella typhi, Salmonella typhimurium, Salmonella enterica), Shigella (e.g., Shigella dysenteriae, Shigella sonnei), Staphylococcus (e.g., Staphylococcus aureus, Staphylococcus epidermidis, Staphylococcus saprophyticus), Streptococcus (e.g., Streptococcus agalactiae, Streptococcus pneumoniae, Streptococcus pyogenes), Treponoma (e.g., Treponoma pallidum), Vibrio (e.g., Vibrio cholerae, Vibrio vulnificus), and Yersinia (e.g., Yersinia pestis).

In some embodiments, a virulence factor can include generally, without limitation, an endotoxin and/or an exotoxin. In some embodiments, a virulence factor can include, without limitation, Cholera toxin, Tetanus toxin, Botulinum toxin, Diphtheria toxin, Streptolysin, Pneumolysin, Alpha-toxin, Alpha-toxin, Phospholipase C, Beta-toxin, Streptococcal mitogenic exotoxin, Streptococcal pyrogenic toxins, Leukotoxin A, hemagglutinin, hemolysin, hyaluronidase, protease, coagulase, lipases, deoxyribonucleases and enterotoxins, M protein, lipoteichoic acid, hyaluronic acid capsule, destructive enzymes (including streptokinase, streptodornase, and hyaluronidase), streptolysin, alin A, internalin B, lysteriolysin O, actA, and Cytolethal distending toxin.

Examples of protozoal pathogens include the following organisms: Cryptosporidium parvum, Entamoeba (e.g., Entamoeba histolytica), Giardia (e.g., Giardia lambila), Leishmania (e.g., Leishmania donovani), Plasmodium spp. (e.g., Plasmodium falciparum, Plasmodium vivax, Plasmodium ovale, Plasmodium malariae), Toxoplasma (e.g., Toxoplasma gondii), Trichomonas (e.g., Trichomonas vaginalis), and Trypanosoma (e.g., Trypanosoma brucei, Trypanosoma cruzi). Libraries for other protozoa can also be produced and used according to methods described herein.

Examples of fungal pathogens include the following: Aspergillus, Candida (e.g., Candida albicans), Coccidiodes (e.g., Coccidiodes immitis), Cryptococcus (e.g., Cryptococcus neoformans), Histoplasma (e.g., Histoplasma capsulatum), and Pneumocystis (e.g., Pneumocystis carinii).

In some embodiments, the analyte/pathogen comprises a virus. Examples of viruses include Poxviruses, Human Cytomegalovirus (CMV), Human Epstein-Barr virus (EBV), Human Herpes Simplex Virus-1 (HSV-1), herpesviruses, and Human adenoviruses.

In some embodiments, a virus is a double-stranded DNA virus (dsDNA). Examples of dsDNA virus families include Adenoviridae, Asfarviridae, Herpesviridae, Iridoviridae, Papillomaviridae, Polyomaviridae, and/or Poxviridae.

In some embodiments, a virus is a single-stranded RNA virus (ssRNA). Examples of ssRNA viruses include Orthomyxoviruses, Arenaviruses, Paramyxoviruses, Bunyaviruses, Filoviruses, and/or Rhabdoviruses

In some embodiments, a virus is a single-stranded DNA virus (ssDNA). Examples of ssDNA viruses include Parvoviruses, Anelloviruses, and/or Circoviruses

In some embodiments, a virus is a double-stranded RNA virus (dsRNA). Examples of dsRNA viruses include Reoviruses and Birnaviruses.

In some embodiments, a virus is a single-stranded RNA virus (ssRNA). Examples of ssRNA viruses include Picornaviruses, Astroviruses, Caliciviruses, Coronaviruses (e.g., SARS-CoV-2), Flaviviruses, Arteriviruses, and Togaviruses.

In some embodiments, a virus includes a herpesviruses. Example herpesviruses include human papillomavirus (HPV) and polyoma viruses such as JC virus and BK virus.

In some embodiments, a fluid sample containing an analyte is a biological sample. In some embodiments, the biological sample is whole blood, serum, plasma, a mucous membrane fluid (of the oral, nasal, vaginal, anal, inner ear, and ocular cavities, ear fluid, a secretion or exudate from a gland, or a secretion or exudate from a lesion or blister, e.g. lesions or blisters on the skin.

In some embodiments, a pathogen/analyte is or comprises a physical, chemical, biological or radiological contaminant. Examples of chemical contaminants include, e.g., nitrogen, bleach, salts, pesticides, metals, toxins produced by bacteria, and human or animal drugs. Examples of biological contaminants include, e.g., bacteria, viruses, protozoan, and parasites. Examples of radiological contaminants include, e.g., cesium, plutonium and uranium.

In some embodiments, an analyte may be or comprise an inorganic substance. In some embodiments, an analyte may be or comprise smoke.

### System

Membrane/Substrate

In some embodiments, a substrate/membrane comprises one or more cellulose-based materials. In some embodiments, a cellulose-based material is or comprises a micron-scale cellulose. In some embodiments, a cellulosic material is or comprises a nano-scale cellulose (i.e. nanocellulose). In some embodiments, nanocellulose is or comprises cellulose nanofibrils. In some embodiments, cellulose nanofibrils are or comprise microfibrillated cellulose, nanocrystalline cellulose, and bacterial nanocellulose.

In some embodiments, a substrate/membrane can be made from one or more polymeric materials, metallic materials, ceramic materials, and/or combinations thereof. In some embodiments, substrates/membranes can be custom fabricated or off the shelf polymeric, ceramic or metallic membranes.

In some embodiments, a substrate/membrane may be a porous membrane, such as a Teflon membrane or made of PTFE, PVDF, Nylon, PP, PES, PA, PS, PAN, Alumina, Silicon Carbide, Tungsten Carbide, Titanium Oxide, Zirconia oxide, Carbon, Stainless Steel, Silver, Palladium, vanadium, tantalum, Nickel, Titanium, metal-ceramic, metal alloys or a combination thereof.

In some embodiments, the surface of the solid substrate may be treated to either promote wetting of the capture liquid or decrease wetting so that the capture liquid may be more easily removed from the surface. This treatment may include, but is not limited to, surface roughening or chemical functionalization.

Dimensions

In accordance with various embodiments, the dimensions of a membrane/substrate (e.g., the surface area, height, width, etc.) may depend on the use of the system (e.g., the environment being sampled). In some embodiments, the dimensions of a system may be relatively small, such as a testing plate or cover (or portion thereof) of an air duct. In some embodiments, a Liquid Net described herein includes only a single fiber (or several fibers) coated with capture liquid.

In some embodiments, the dimensions of a system may be relatively large, such as a wall covering, tent, or other structure or portion thereof. The Liquid Net may cover a portion of or all of the structure (e.g., wall covering, tent, etc.).

In some embodiments, the dimensions of the membrane/substrate are such that it can retrieve an analyte/pathogen that is about 1 μm in size or less (e.g., a bacteria). In some embodiments, the dimensions of the membrane/substrate are such that it can retrieve an analyte/pathogen that is about 150 nm in size or less (e.g., a virus).

In some embodiments, a membrane/substrate comprises a surface area is at least 1 mm² (e.g., at least 10 mm², at least 100 mm², at least 1.0 m², at least 10 m², at least 100 m²). In some embodiments, a membrane/substrate comprises a surface area is at most 1000 mm². In some embodiments, a membrane/substrate comprises a surface area is within the range of about 1 mm² to 1000 mm² (e.g., 10 to 1000 mm², 100 to 900 mm², 200 to 700 mm², 400 to 500 mm², etc.).

In some embodiments, a membrane/substrate comprises a length or diameter that is at least 0.1 mm. In some embodiments, a membrane/substrate comprises a length or diameter that is at most 100 mm. In some embodiments, a membrane/substrate comprises a length or diameter that is within the range of about 0.1 mm to 100 mm (e.g., 1.0 mm to 90.0 mm, 10.0 mm to 80.0 mm, 20.0 mm to 60.0 mm, 30.0 mm to 50.0 mm, etc.). In some embodiments, a membrane/substrate comprises a length or diameter that is less than 0.1 mm (i.e., is nanoscale).

In some embodiments, a membrane/substrate comprises a thickness that is at least 0.01 mm. In some embodiments, a membrane/substrate comprises a thickness that is at most 100 mm. In some embodiments, a membrane/substrate comprises a thickness that is within the range of about 0.01 mm to 100 mm (e.g., 0.01 mm to 10.0 mm, 0.1 mm to 50.0 mm, 1.0 mm to 10.0 mm, etc.).

In some embodiments, a membrane/substrate comprises a thickness that is more than 100 mm (e.g., more than 1.0 cm, more than 10 cm, more than 20 cm, more than 30 cm, more than 40 cm, more than 50 cm, more than 60 cm, more than 70 cm, more than 80 cm, more than 90 cm, more than 100 cm). In some embodiments, where the dimensions of the system are relatively large, the membrane/substrate thickness can be on the order of several meters, e.g., up to 100 m (e.g., up to 1 meter, up to 10 meters, up to 20 meters, up to 30 meters, up to 40 meters, up to 50 meters, up to 60 meters, up to 70 meters, up to 80 meters, up to 90 meters, etc.).

In some embodiments, the where the dimensions of the system are relatively small, the membrane/substrate thickness can be nanoscale, (e.g., less than 1.0 μm, less than 900 nm, less than 800 nm, less than 700 nm, less than 600 nm, less than 500 nm, less than 400 nm, less than 300 nm, less than 200 nm, less than 100 nm, less than 90 nm, less than 80 nm, less than 70 nm, less than 60 nm, less than 50 nm, less than 40 nm, less than 30 nm, less than 20 nm, less than 10 nm, less than 5 nm, less than 2 nm). In some embodiments, the membrane/substrate thickness is at least 1.0 nm.

In accordance with various embodiments, provided systems may be configured such that they may be placed within (e.g., removably placed within) a housing/cartridge.

Porosity

In some embodiments, pore size can be an important factor in facilitating or determining a desired recirculation rate of the air within the environment being sampled from (e.g., spacecraft, hospital, etc.).

In some embodiments, the mean diameter of the pores within the substrate/membrane is within a range of about 1 nm to 100 μm. In some embodiments, the mean diameter of the pores within the substrate/membrane is at least 1 nm. In some embodiments, the mean diameter of the pores within the substrate/membrane is at most 100 μm.

In some embodiments, pores are formed via a plurality of fibers that form a web or net-like structure.

In some embodiments, a substrate/membrane contains substantially homogenous porosity and/or pore size. In some embodiments, a substrate/membrane comprises a heterogeneous arrangement of pores or various sizes.

In some embodiments, pores within a substrate/membrane have an average diameter between 1 nm-10 cm. In some embodiments, pores within a substrate/membrane have an average diameter between 1-20 nm (e.g., 1-15 nm, 1-10 nm, 1-5 nm, 2-20 nm, 3-15 nm, 5-20 nm, 5-15 nm, 5-10 nm, 10-20 nm, etc.). In some embodiments, pores within a membrane have an average diameter of between 10-500 nm (e.g., 10-400 nm, 10-300 nm, 10-200 nm, 10-100 nm, 10-50 nm, 20-500 nm, 20-400 nm, 20-300 nm, 20-200 nm, 20-100 nm, 30-500 nm, 40-500 nm, 50-500 nm, 60-500 nm, 70-500 nm, 80-500 nm, 90-500 nm, 100-500 nm, etc.). In some embodiments, pores within a membrane have an average diameter of between 0.5 μm to 100 μm (e.g., 0.5-50 μm, 1.0-40 μm, 10-20 μm, etc.). In some embodiments, pores within a membrane have an average diameter of between 100 μm to 1.0 mm. In some embodiments, pores within a membrane have an average diameter of between 1.0 mm to 100 mm. In some embodiments, pores within a membrane have an average diameter of between 100.0 mm to 1.0 cm. In some embodiments, pores within a membrane have an average diameter of between 1.0 cm to 10 cm. In some embodiments, pore size/morphology can be determined investigated using scanning electron microscopy (SEM).

In some embodiments, pores within a substrate/membrane are filled with capture liquid. In some embodiments, pores within a substrate/membrane are not filled with the capture liquid (e.g., the capture liquid is substantially not present in at least some or all of the pores).

Capture Liquid

In some embodiments, properties (e.g., viscosity and volume) of a capture liquid coating can affect the release of pathogens/analytes from the surface of membrane/substrate.¹²

In some embodiments, the capture liquid has an affinity to the substrate/membrane surface.

In some embodiments, the capture liquid fills the pores of the substrate can be utilized. In some embodiments, the capture liquid does not fill the pores of the substrate/membrane. In some embodiments, the capture liquid has a positive affinity for the surface or functionalized groups on the surface or pores of the membrane/filter, resulting in a better retention of the liquid on the surface. In some embodiments, the capture liquid has a negative affinity for the surface or functionalized groups on the surface or pores of the membrane/filter, resulting in an easier removal of the liquid from the surface.

In some embodiments, the capture liquid has a higher affinity with the substrate/membrane surface as compared to the sample fluid.

In some embodiments, the capture liquid can be selected from a number of different fluids. These fluids can be selected based on their biocompatibility, low (or high) toxicity, anti-clotting performance, chemical stability under physiological conditions, and low levels of leaching from the pore surfaces. Some examples include hydrocarbons, perfluorinated fluids, liquid silicone elastomers and other vegetable and mineral oils. In some embodiments, the capture liquid may comprise two or more fluids.

In some embodiments, the capture liquid can be or comprise a chemically-inert, high-density biocompatible fluid. In some embodiments, the capture liquid can be or comprise a polar or a non-polar liquid. In some embodiments, the capture liquid can be or comprise a perfluoropolyether. In some embodiments, the capture liquid can be or comprise water.

In some embodiments, the capture liquid comprises a volume of liquid that is at least 1 μl/cm². In some embodiments, the capture liquid comprises a volume of liquid that is at most 100 ml. In some embodiments, the capture liquid comprises a volume of liquid that is at least enough to cover the active side (i.e., environment facing or “environment side”) of the membrane). In some embodiments, the capture liquid comprises a volume of liquid that is at least great enough such that the pores of the membrane are partially filled or filled with the capture liquid. In some embodiments, the capture liquid comprises a volume of liquid that is within the range of 1 μl and 100 ml/cm² (e.g., 10 μ/cm² 1-80 ml/cm², 100 μ/cm² 1-70 ml/cm², 500 μl/cm²-50 ml/cm², 1 ml/cm²-40 ml/cm², 10 ml/cm²-20 ml/cm², etc.)

In some embodiments, the capture liquid is or comprises a fluid with a viscosity of at least 0.1 cSt. In some embodiments, the capture liquid is or comprises a fluid with a viscosity of at most 25,000 cSt. In some embodiments, the capture liquid is or comprises a fluid with a viscosity of about 80-90 cSt. In some embodiments, the capture liquid is or comprises a fluid with a viscosity of about 1500-1600 cSt. In some embodiments, the capture liquid is or comprises a fluid with a viscosity of between 1-2000 cSt (e.g., between 10-500 cSt, 20-400 cSt, 30-300 cSt, 40-200 cSt, 50-100 cSt, 60-90 cSt, 70-85 cSt, 500-2000 cSt, 600-1800 cSt, 700-1700 cSt, 800-1600 cSt, 1500-1600 cSt, etc.)

Compatibility with Other Systems/Devices

It is contemplated that various embodiments, as an addition or alternative to functioning as a standalone assay system, may also be integrated into a larger system (e.g., a pre-existing system, e.g., an HVAC system). Further, in some embodiments, the system is compatible with an air filtration system, a water filtration system, or HVAC system.

In some embodiments, a system is integrated into a larger system (e.g., an HVAC system) for monitoring in an existing filtration setup.

In some embodiments, the system can be fabricated as an in-line insert to be removably placed in front of other high-throughput filtration systems, e.g. HEPA filters. In some embodiments, the system is an in-line insert of a HEPA filtration system that is present in environments such as hospitals (e.g., surgical suites), medivacs, clean rooms, etc. or generally in high traffic areas such as restaurants, malls, and public transportation. In some embodiments, the system is an in-line insert of a HEPA filtration system that is present on airplane or in space (e.g., on the International Space Station).

### Methods of Use

In some embodiments, methods of using systems encompassed by the present disclosure include methods for isolating/detecting one or more pathogen(s)/analyte(s) in a fluid sample. In some embodiments, methods include providing a system comprising a substrate/membrane and a chamber; contacting a substrate/membrane with the fluid sample; applying pressure to the active side or chamber side of the substrate/membrane so that at least a portion of the fluid sample flows from the active side through the pores/fibers of the substrate/membrane to the chamber side; removing the pressure for a specified period of time to allow the at least a portion of the fluid sample comprising the pathogen/analyte to return to the active side; and determining the presence of the pathogen/analyte.

In some embodiments, methods of the present invention may further include, e.g., collecting the pathogen/analyte from the active side of the substrate/membrane. In some embodiments, collecting the fluid containing the pathogen/analyte comprises a physical or chemical means. In some embodiments, a physical means comprises pipetting the fluid containing the pathogen/analyte from the active side of the substrate/membrane.

In some embodiments, contacting the substrate/membrane with the fluid sample comprises exposing the substrate/membrane to air on the active side of the substrate/membrane. In some embodiments, contacting the substrate/membrane with the fluid sample comprises spraying the fluid sample on the active side of the substrate/membrane.

In some embodiments, applying pressure to the active side or chamber side of the substrate/membrane comprises applying a negative pressure to the substrate/membrane.

In some embodiments, the recovery time of a membrane (e.g., the time in which the pressure is removed from the system) may affect the performance of the membrane. In some embodiments, a recovery time is within the range of about 1 minute to 1 hour. In some embodiments, recovery time may be adjusted based on the type of capture liquid used. For example, in systems where a higher viscosity capture liquid is used, a longer recovery time may be used due to the system taking longer to equilibrate. In some embodiments, a recovery time is within the range of about 1 hour to 24 hours. In some embodiments, the recovery time is extended beyond 24 hours.

In some embodiments, pores within a substrate/membrane are filled with the capture liquid. In some embodiments, pores within a substrate/membrane are not filled with the capture liquid. After filtration occurs, the capture liquid can be stripped off via mechanical or chemical methods to recover particles. Additional liquid can be added to the non-active side to create a flat surface layer of liquid supporting particles on the active side for recovery.

### Manufacturing

In some embodiments, the capture liquid may be directly pipetted onto filter substrate. In some embodiments, a substrate/membrane can be submerged into bath of a liquid layer (which may be comprised of a plurality if liquids) until fully coated. In some embodiments, the liquid may be added to the surface in a roll coating process, a roll-to-roll coating process, spray coating process, or electrode position process.

In some embodiments, a substrate/membrane can be placed in a cartridge/housing to maintain a self-contained vessel and/or to facilitate compatibility with an existing system (e.g., an HVAC or other system). In some embodiments, placement into a cartridge/housing also prevents contamination and contact spread of the liquid layer. In some embodiments, a substrate/membrane can be incorporated into a system by attaching the substrate/membrane via a clasp, Velcro, hooks, tape, and/or anything that can secure the substrate/membrane to an existing system.

In some embodiments, the system can be assembled from off-the-shelf components including existing air or water filtration membranes and capture liquids. In some embodiments, the system can be manufactured by fabricating porous membranes using melt-pressing, solution casting, phase inversion, electrospinning, melt-spinning, cold-stretching, micromolding, manual punching, thermally-induced phase separation, phase-separation micromolding, sputtering, interfacial polymerization, or extruding, 3D printing, among others. Specialized capture liquids may be fabricated using chemical reactions to produce hybrid or specialized molecules.

### EXEMPLIFICATION

### Example 1: Capturing E. Coli with Liquids

The present Example tests various parameters of liquid nets for capture and release of aerosolized pathogens. The parameters include viscosity and volume of the overlayer, recovery period and pore size.

In this example, a perfluoropolyether liquid layer was tested on a Polytetrafluoroethylene (PTFE) filter. The membranes tested had a diameter ˜18 mm to fit within a housing.

Escherichia coli in phosphate buffer solution was aerosolized and tested against bare PTFE Liquid Nets.

Viscosity and Volume of the Overlayer Liquid

Previous studies have shown that the viscosity of the overlayer affects the release of biofilms from the surface of water filtration membranes (Overton et al., 2017). Additionally, in this example we tested the effects of the thickness of the liquid overlayer on the amount of pathogen released from the Liquid Net.

Volumes of 90 μL (low) and 180 μL (high) of overlayer were tested.

Viscosities of 82 cSt (low) and 1535 cSt (high) were tested.

Recovery Period

Recovery time has been shown to affect the fouling resistance of water purification membranes coated with liquids (Overton et al., 2017). After the Liquid Nets were exposed to the aerosolized bacterial load, the Liquid Nets were set aside for either 15 or 30 minutes. This recovery time allowed the liquid overlayer to fill the pores and push the capture bacteria to the environment-facing surface of the liquid overlayer.

Pore Size

Pore size can be important for the recirculation rate of the air within the environment being tested.

PTFE Liquid Nets containing one- and ten-micron pore sizes were tested for capture and release of aerosolized E. coli GFP.

Results

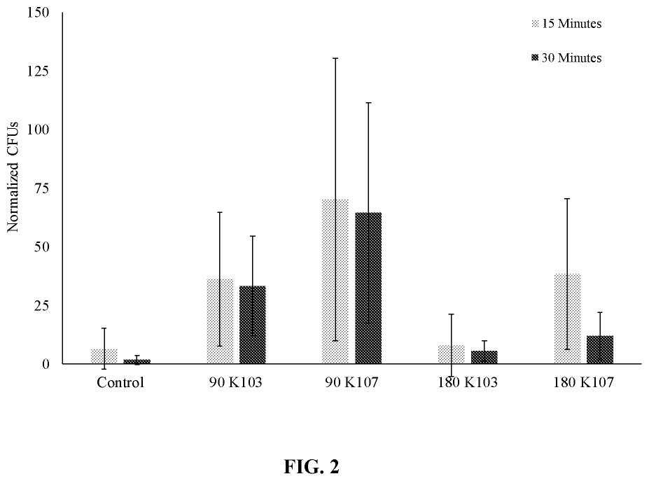

Preliminary data shown in FIG. 2, using Liquid Nets fabricated on filters with a 1-micron pore size, indicates that a lower overlayer volume and rest time and higher viscosity may increase aerosolized pathogen capture and release.

### Example 2: Liquid Net Configuration with Air Filtration Device and Mechanism of Removal of Target Particles

The present Example shows an exemplary configuration of a Liquid Net that is configured as an in-line addition to an air purification device. In this Example, a Liquid Net is constructed and dimensioned so that it can attach and cover a portion of the face of the “active side” (also referred to herein as the “environment side”) of an air purification device.

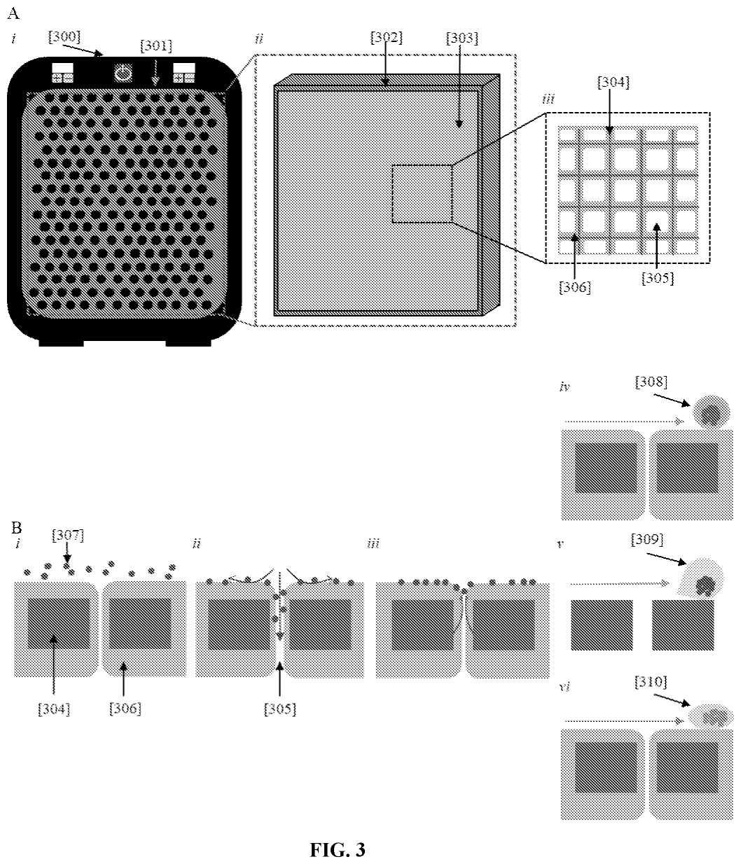

The exemplary configuration of this Example is shown in FIG. 3, panel A as an in-line addition to an air purification device. Briefly, (i) an air purifier [300] with an intake area [301] is covered with (ii) a Liquid Net either directly attached or as a separate insert. The Liquid Net includes a support structure [302] and the active surface [303]. The (iii) active surface itself consists of [304] the fibers/solid material supporting the liquid and [306] the liquid itself. In some embodiments, there are [305] spaces between the liquid-coated fibers.

FIG. 3, panel B diagrams the process of collection and removal from Liquid Nets as part of the air purification device of FIG. 3, panel A. In FIG. 3, panel B, (i) shows an aerosol containing particulates of interest [307] is exposed to a Liquid Net consisting of [304] a solid substrate and [306] a liquid coating (seen in cross section). (ii) When the aerosol is pulled across the membrane and through the pores [305], some of the particulates become associated with the liquid surface. (iii) When the filtration stops, in some embodiments the liquid may assist in pushing the particulates of interest outward/upward as the liquid re-equilibrates. To collect or remove the particulates from the surface, a variety of methods can be used, including (but not limited to) (iv) the use of a collection liquid that is immiscible with the Liquid Net coating liquid [308], e.g. water, which passes over the coating liquid and either solubilizes the particulates or removes the top layer of the coating liquid, (v) the removal of all or a substantial amount of the coating liquid, and the particulates along with it, via a compatible solute [309], or (vi) the mechanical removal of the top portion of the coating liquid along with the particulates contained therein [310].

Configurations of the membrane of the Liquid Net as shown in FIG. 3 were contemplated and will be tested to determine which are most efficacious in capturing a target particle in various settings and for various target particles.

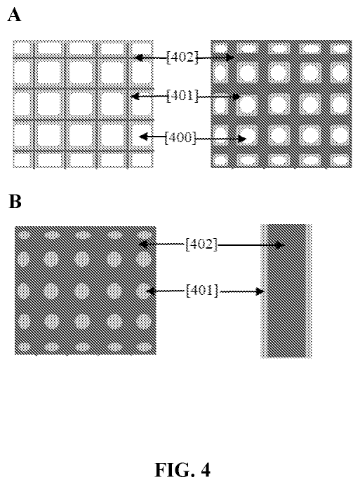

FIG. 4 shows a schematic of the front views of three different configurations of a capture liquid [401] coating the pores mesh and/or surface of a filter or membrane [402], with or without leaving open pores [400] in between the coated fibers, according to some embodiments. Panel A shows the top view of two examples of a configuration where there are pores in between the coated figures. Panel B shows one top view of a configuration where there are not open pores between the coated fibers (left) as well as one side view (right) of a mesh/filter/membrane section with the coating liquid on both sides (i.e., both the “active” side and the “chamber” side). All of these schematics are for systems that are not under pressure, i.e., not actively filtering.

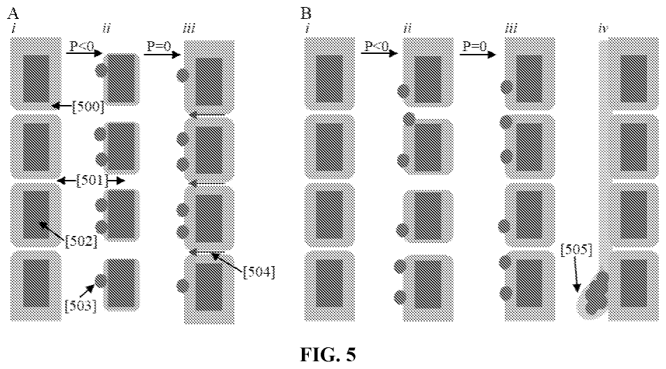

FIG. 5 depicts two different modes of action of the capture liquid on the membrane, represented in cross-section. FIG. 5, panel A shows (i) the capture liquid [500] initially filling or almost filling the pores or gaps [501] between the solid mesh/filter/membrane material [502]. When pressure is applied across the membrane (ii), filtration begins and target particles [503] are captured in/on the liquid. When pressure is released (iii), the liquid re-equilibrates, which may force the target particles toward the membrane surface [504] (active side). In FIG. 5, panel B, the same process of (i) initial status, (ii) filtration/particle capture, and (iii) resting occurs but with more space between the capture liquid layer in the pores. In this embodiment, the increasing diameter of the pore due to the retraction of the capture liquid in the pores upon the application of pressure, followed by the decreasing diameter of the pore due to the advancement of the capture liquid when pressure is released, contributes to the movement of the target particles to the surface. In (iv), the target particles are shown being removed from the capture liquid surface via a second liquid [505] that is immiscible with the capture liquid but chemically compatible with the target particles (e.g. water), in one embodiment.

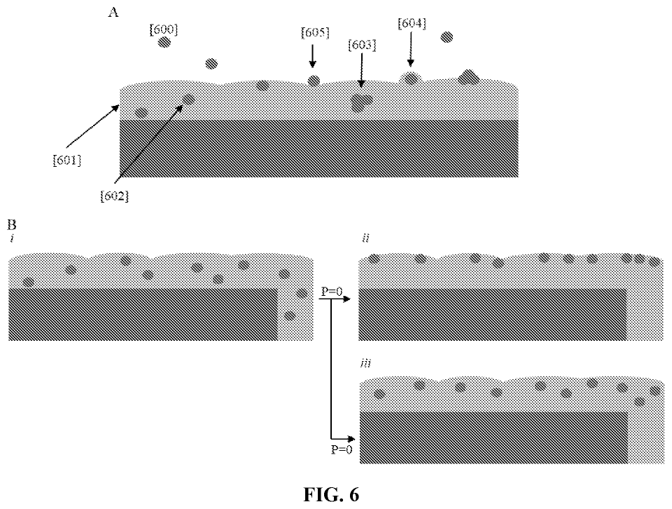

Additionally, FIG. 6 describes several possible interactions of the target particles [600] with the capture liquid [601]. Panel A shows examples in which the target can be embedded in the liquid either as a single particle [602] or a group of particles [603], or situated on top of the capture liquid either with [604] or without [605] a cloaking/wrapping layer of capture liquid over the particle. Panel B shows how the arrangement of particles within the liquid may change as the system approaches equilibrium after filtration in some embodiments: (i) shows the particles assembling at the capture liquid/filtration fluid interface during filtration. When pressure is released, (ii) shows the target particles moving close to the surface, while (iii) shows the particles equilibrating but remaining embedded within the liquid.

### Example 3: Effectiveness of Liquid Nets in Capturing Aerosolized E. coli

Various parameters for Liquid Nets were tested for their effect on the capture and release of aerosolized pathogens (in this Example, aerosolized E. coli). The release of the aerosolized particles is important, for example, because releasing particles intact allows for testing and analysis of the particles. Parameters tested included viscosity and volume of the capture liquid, recovery period, and pore size.

Methods

A solution of E. coli (0.43 au @ 600 nm, ˜1.2×10⁶ cells/mL) was aerosolized at a rate of ˜0.5 mL and pulled across a polytetrafluoroethylene membrane with 1.0 μm pores coated with either a thin (80 uL) or thick (160 uL) layer of a perfluoropolyether capture liquid (DuPont Krytox 10X) with either a low (Kyrox 103 [K103]) or high (Kyrox 107 [K107]) viscosity (30 and 450 cSt, respectively) for 6 minutes. Controls include uncoated (no capture liquid) controls.

Following filtration, the membranes were stamped onto bacterial growth media sequentially nine times and the number of colony-forming units (CFU) at each stamp counted. There were three replicates per membrane type.

Results

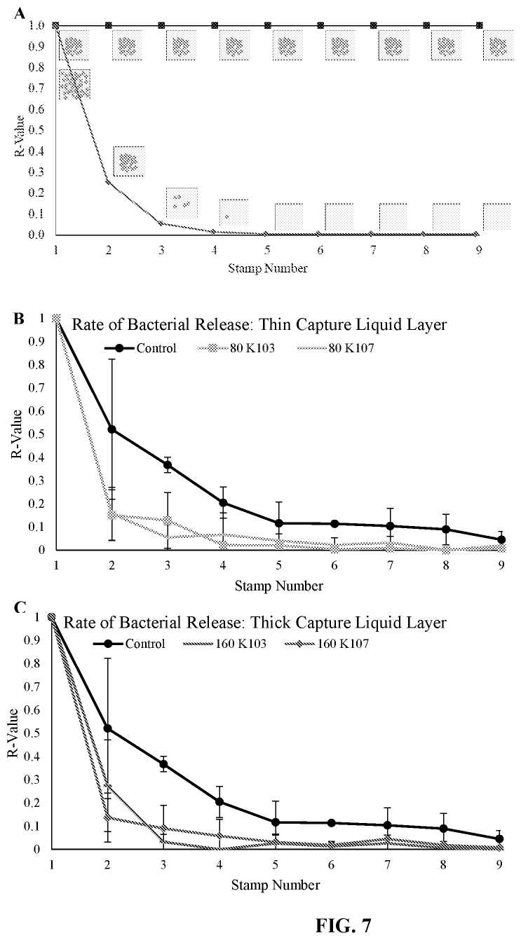

FIG. 7 shows data on the effectiveness of one embodiment of a Liquid Net device and method described herein at capturing aerosolized Escherichia coli K12 (GFP expressing) in phosphate-buffered saline droplets. Panel A shows an example set of data describing how the calculation was made; namely, that the number of E. coli colony-forming units (CFUs) is normalized by dividing the CFU number obtained from the nth pass of a mechanical collection (stamping) by the number obtained from the first pass, hereafter referred to as “R-value”. A filter surface that releases the same number of bacteria at each pass/stamp yields a straight line, while a filter that allows for more removal with fewer passes shows an exponential decrease. This metric was adopted to minimize the natural variation present in aerosolized bacterial cultures. Panel B shows the data from a PTFE membrane either uncoated (control) or coated with 80 μl of Krytox 103 (80 K103) or 80 μl of more viscous Krytox 107 (80 K107). Panel C shows the same data, except with a thicker layer of capture liquid: 160 μl of Krytox 103 (160 K103) or 160 μl of Krytox 107 (160 K107).

The results showed that nearly all of the bacteria were removed on the first stamp for the membranes coated with a capture liquid, as demonstrated by the consistently lower StampN/Stamp1 values compared to the un-coated controls. These results were found to be consistent for both viscosities tested, as well as both coating liquid thicknesses, indicating the robustness of the approach.

### Example 4: Liquid Nets with 1.0 and 10.0 μm Pores for Capturing Aerosolized E. coli

Additional experiments were conducted testing the efficacy of the Liquid Nets described herein to capture and release aerosolized E. coli. Parameters tested included viscosity and volume of the capture liquid, recovery period, and pore size.

Methods

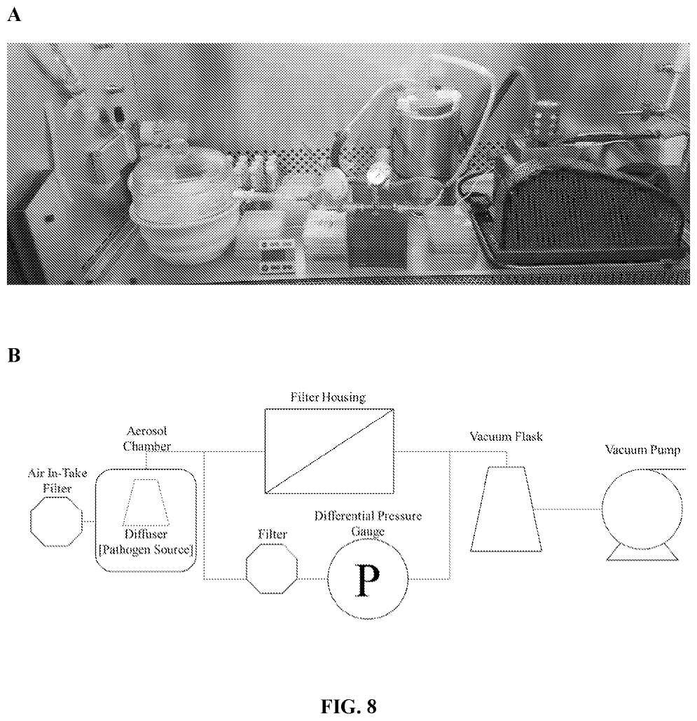

FIG. 8 shows the experimental setup used in this Example to test Liquid Nets. The setup includes an air in-take filter and an aerosol chamber with a diffuser that includes the source of the pathogen (e.g., E. coli). The system is connected to a Liquid Net which is connected to a vacuum pump to apply pressure (applied from the inner side or “chamber side”) as the aerosolized particles are exposed to the outer or “active side”.

A solution of E. coli (0.43 au @ 600 nm, ˜1.2×10⁶ cells/mL) was aerosolized at a rate of ˜0.5 mL and pulled across a polytetrafluoroethylene membrane. Membranes with a pore size of 1.0 and 10.0 μm were tested. 1.0 μm pores were coated with either a thin (80 uL) or thick (160 uL) layer of a perfluoropolyether capture liquid (DuPont Krytox 10X) with either a low (Kyrox 103 [K103]) or high (Kyrox 107 [K107]) viscosity (82 and 1535 cSt, respectively) for 6 minutes. Controls include uncoated (no capture liquid) controls. 10.0 μm pores were coated with either a thin (40 uL) or thick (80 uL) layer of a perfluoropolyether capture liquid (DuPont Krytox 10X) with either a low (Kyrox 103 [K103]) or high (Kyrox 107 [K107]) viscosity (82 and 1535 cSt, respectively) for between 3 and 6 minutes. Controls include uncoated (no capture liquid) controls. 0, 15, and 30-minute recovery times were tested.

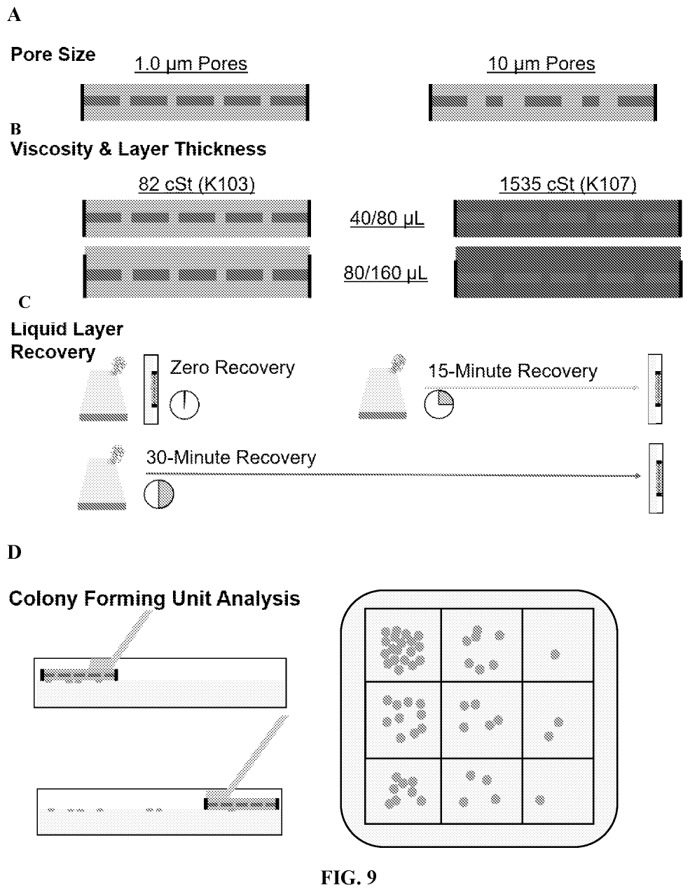

FIG. 9 shows an illustration of exemplary parameters investigated for systems described herein in further experiments. Panel A shows exemplary pore sizes that were tested. Panel B shows exemplary viscosity and layer thickness testing parameters. Panel C shows liquid layer recovery times after exposure to aerosolized bacteria (including 0 recovery, 15 minute recovery, and 30 minute recovery). Panel D shows a schematic of the mechanical removal or stamping process used to generate the data.

Following filtration, the membranes were stamped onto bacterial growth media sequentially nine times and the number of colony-forming units (CFU) at each stamp counted. There were three replicates per membrane type.

Results

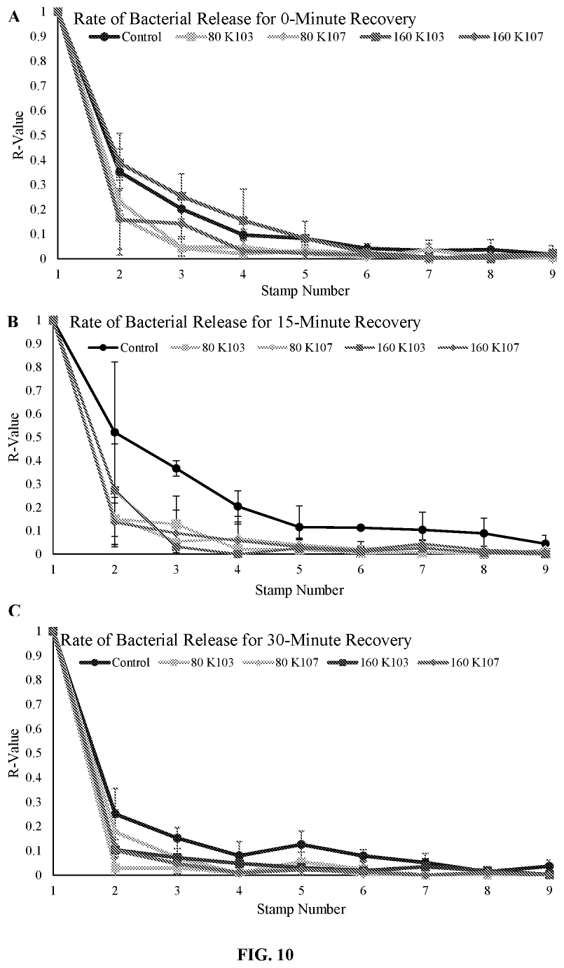

FIG. 10 shows exemplary data regarding the rate of bacterial cell retrieval using Liquid Nets with 1.0 μm pores for various recovery times, or periods of rest which allow the liquid coating to re-equilibrate. Rate of bacterial retrieval measures effectiveness of the membrane in transferring the captured target particle (here, E. coli CFUs) after the first pass of mechanical liquid removal or “stamp”, as illustrated in FIG. 9, panel D, and calculated as illustrated in FIG. 7, panel A. The groups tested include an uncoated “control”, “80K103” (80 μl of lower-viscosity Kyrtox 103 capture liquid), “80K107” (80 μl of higher-viscosity Krytox), “160K103” (160 μl of Krytox 103), and “160K107” (160 μl of Krytox 107). FIG. 10, Panel A shows the rate of bacterial release after a 0-minute recovery. FIG. 10, Panel B shows the rate of bacterial release after a 15-minute recovery. FIG. 10, Panel C shows the rate of bacterial release after a 30-minute recovery.

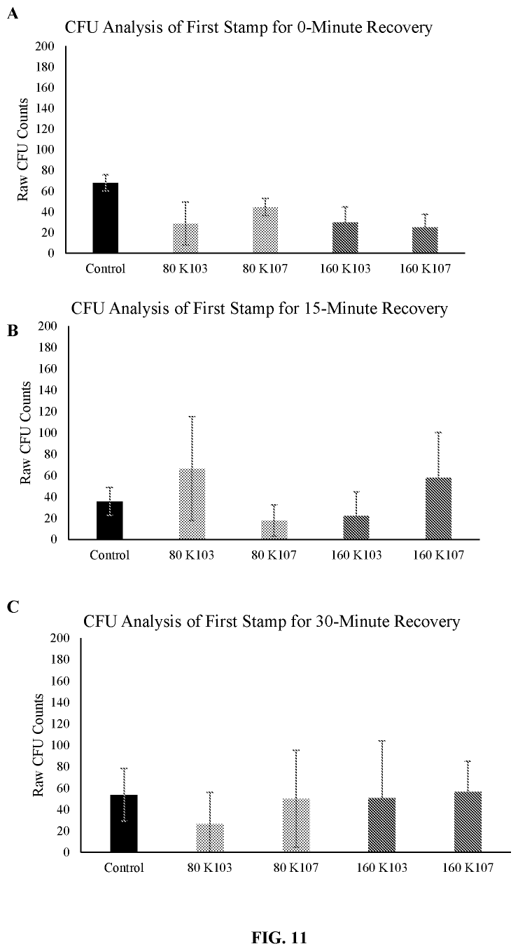

FIG. 11 shows exemplary data showing the amount of CFUs of E. coli that were transferred after first pass of mechanical removal/stamp, as illustrated in FIG. 9 and calculated as shown in FIG. 7, panel A, using Liquid Nets with 1.0 μm pores for 0-minute recovery (FIG. 11, Panel A), 15-minute recovery (FIG. 11, Panel B), and a 30-minute recovery (FIG. 11, Panel C). The groups tested include an uncoated “control”, “80K103” (80 μl of lower-viscosity Kyrtox 103 capture liquid), “80K107” (80 μl of higher-viscosity Krytox 107 liquid), “160K103” (160 μl of Krytox 103), and “160K107” (160 μl of Krytox 107).

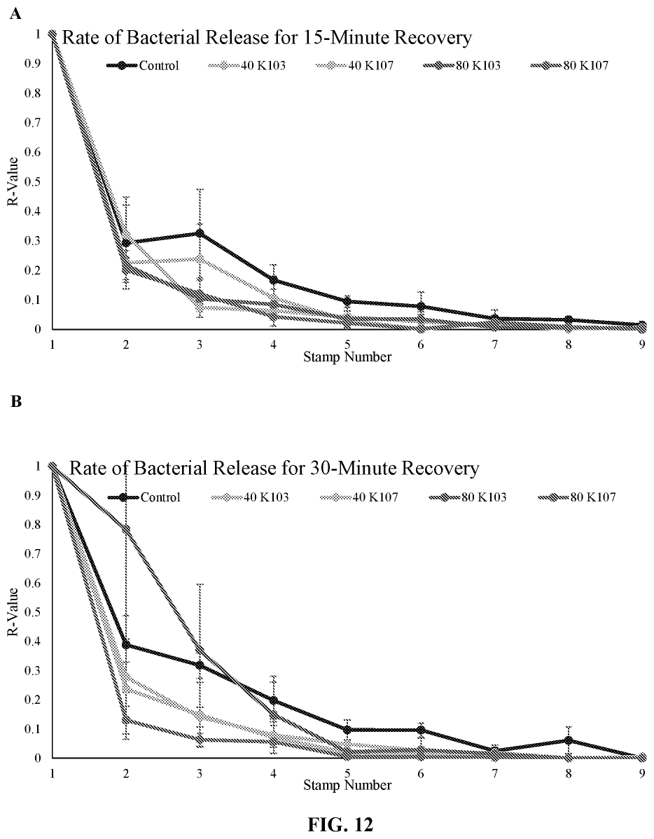

FIG. 12 shows exemplary data regarding the rate of bacterial cell retrieval using Liquid Nets with 10.0 μm pores for various recovery times. Rate of bacterial retrieval measures effectiveness of the membrane in transferring the captured target particle (here, E. coli CFUs) after the first pass of mechanical liquid removal or “stamp”, as illustrated in FIG. 9, panel D, and calculated as illustrated in FIG. 7, panel A. The groups tested include an uncoated “control”, “40K103” (40 μl of lower-viscosity Kyrtox 103 capture liquid), “40K107” (40 μl of higher-viscosity Krytox 107 liquid), “80K103” (80 μl of Krytox 103), and “80K107” (80 μl of Krytox 107). FIG. 12, Panel A shows the rate of bacterial cell retrieval after a 15-minute recovery. FIG. 12, Panel B shows the rate of bacterial release after a 30-minute recovery.

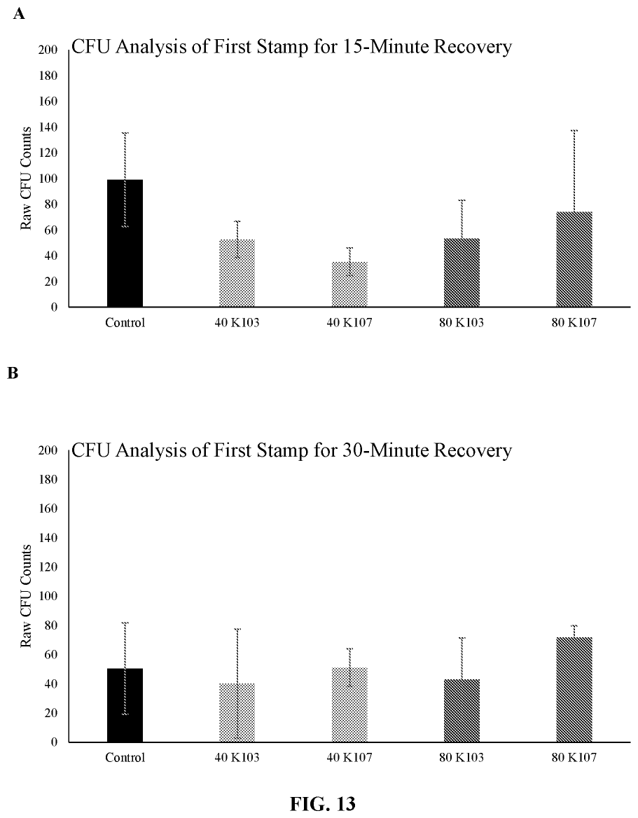

FIG. 13 shows the amount of CFUs of E. coli that were transferred after first stamp using Liquid Nets with 10.0 μm pores for 15-minute recovery (FIG. 13, Panel A), and 30-minute recovery (FIG. 13, Panel B). The groups tested include an uncoated “control”, “40K103” (40 μl of Krytox 103 capture liquid), “40K107” (40 μl of Krytox 107), “80K103” (80 μl of Krytox 103), and “80K107” (80 μl of Krytox 107).

### Example 5: Liquid Nets Fabricated on Commercial HEPA Filters for Capturing Aerosolized E. coli

In this example, the described Liquid Nets were configured with a commercially available HEPA filter. Aerosolized particles were applied to the system and the ability of the system to retrieve the target particles from the surface of the Liquid Net was tested.

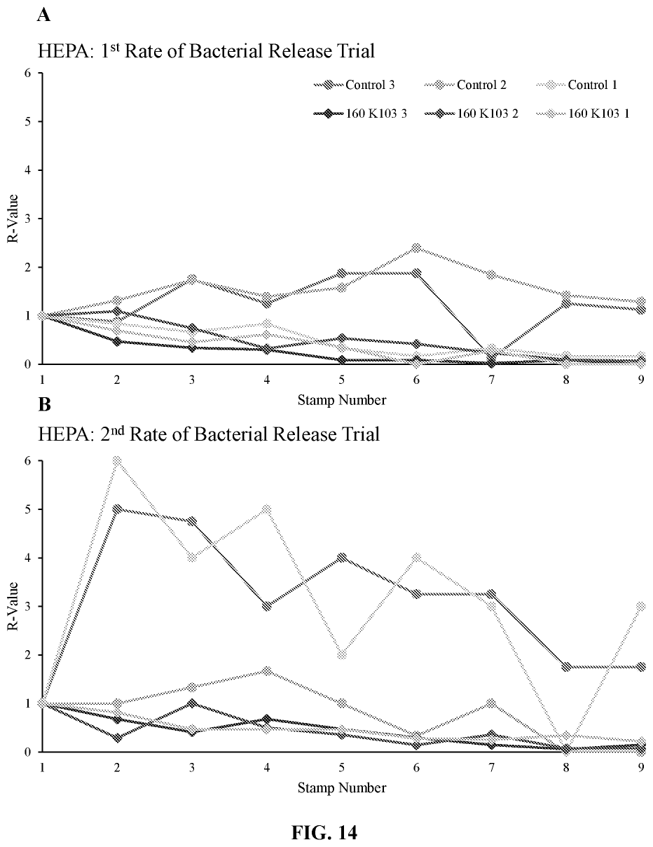

FIG. 14 shows exemplary data regarding the rate of bacterial cell retrieval using Liquid Nets made using PFPE capture liquids (Krytox) on commercially-available HEPA filters. Rate of bacterial retrieval measures effectiveness of the membrane in transferring the captured target particle (here, E. coli CFUs) after the first pass of mechanical liquid removal or “stamp”, as illustrated in FIG. 9D, and calculated as illustrated in FIG. 7, panel A. The groups tested include an uncoated “control”, “160K103” (160 μl of Krytox 103) with three independent replicates 3, 2, and 1 shown. Data from two separate trials are shown.

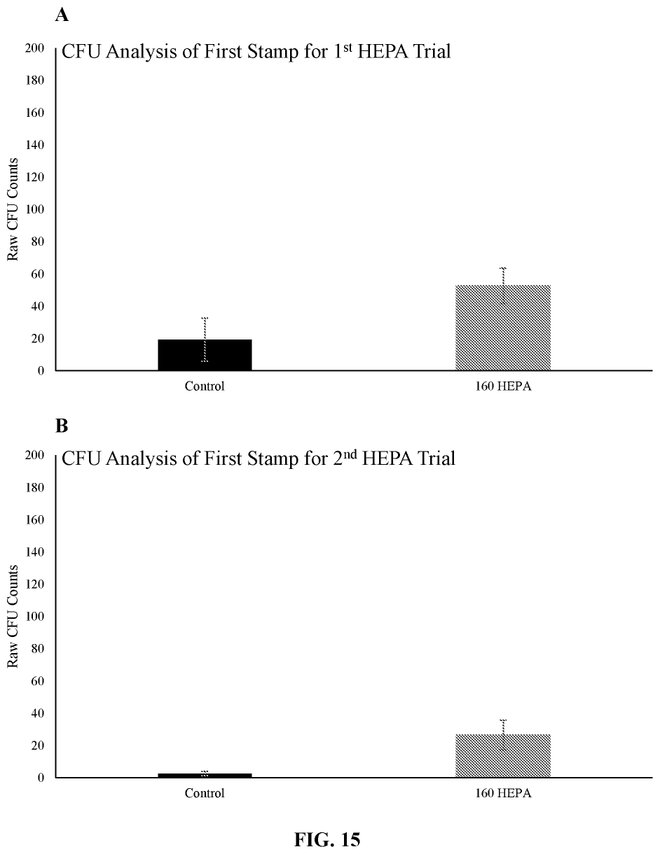

FIG. 15 shows exemplary data regarding the amount of CFUs of E. coli that were transferred after first stamp using Liquid Nets made using PFPE capture liquids (Krytox) on commercially-available HEPA filters. The groups tested include an uncoated “control” and “160HEPA” (160 μl of Krytox). Data from two separate trials are shown in FIG. 15, panels A and B.

### REFERENCES

(1) Taylor, P. W. Impact of Space Flight on Bacterial Virulence and Antibiotic Susceptibility. Infect. Drug Resist. 2015, 8, 249-262.
(2) Rosenzweig, J. A.; Abogunde, O. Spaceflight and Modeled Microgravity Effects on Microbial Growth and Virulence. Appl. Microbiol. Biotechnol. 2010, 85, 885-891. https://doi.org/10.1007/s00253-009-2237-8.
(3) Fajardo-cavazos, P.; Nicholson, W. L. Cultivation of Staphylococcus Epidermidis in the Human Spaceflight Environment Leads to Alterations in the Frequency and Spectrum of Spontaneous Rifampicin-Resistance Mutations in the RpoB Gene. Front. Microbiol. 2016, 7, 1-10. https://doi.org/10.3389/fmicb.2016.00999.
(4) Mermel, L. A. Infection Prevention and Control During Prolonged Human Space Travel. Healthc. Epidemiol. 2013, 56, 123-130. https://doi.org/10.1093/cid/cis861.
(5) World Health Organization. Managing Epidemics: Key Facts about Major Deadly Diseases; Geneva, 2018.
(6) Mattner, F.; Bange, F.; Meyer, E.; Seifert, H.; Wichelhaus, T. A.; Chaberny, I. F. Preventing the Spread of Multidrug-Resistant Gram-Negative Pathogens. Dtsch. Arztebl. Int. 2012, 109 (3), 39-45. https://doi.org/10.3238/arzte.
(7) Edelsberg, J.; Weycker, D.; Barron, R.; Li, X.; Wu, H.; Oster, G.; Badre, S.; Langeberg, W. J.; Weber, D. J. Prevalence of Antibiotic Resistance in US Hospitals. Diagn. Microbiol. Infect. Dis. 2014, 78 (3), 255-262. https://doi.org/10.1016/j.diagmicrobio.2013.11.011.
(8) Fronczek, C. F.; Yoon, J. Biosensors for Monitoring Airborne Pathogens. J. Lab. Autom. 2015, 20 (4), 390-410. https://doi.org/10.1177/2211068215580935.
(9) Kelly-wintenberg, K.; Sherman, D. M.; Member, S.; Tsai, P. P.; Gadri, R. Ben; Karakaya, F.; Member, S.; Chen, Z.; Member, S.; Roth, J. R.; et al. Air Filter Sterilization Using a One Atmosphere Uniform Glow Discharge Plasma (the Volfilter). IEEE Trans. Plasma Sci. 2000, 28 (1), 64-71.
(10) Kowalski, W. J.; Bahnfleth, W. P.; Whittam, T. S. Filtration of Airborne Microorganisms: Modeling and Prediction; 1999, Vol. 4273.
(11) Hou, X.; Hu, Y.; Grinthal, A.; Khan, M.; Aizenberg, J. Liquid-Based Gating Mechanism with Tunable Multiphase Selectivity and Antifouling Behaviour. Nature 2015, 519, 70-73. https://doi.org/10.1038/nature14253.
(12) Overton, J. C.; Weigang, A.; Howell, C. Passive Flux Recovery in Protein-Fouled Liquid-Gated Membranes. J. Memb. Sci. 2017, 539, 257-262.
(13) Alvarenga, J.; Ainge, Y.; Williams, C.; Maltz, A.; Blough, T.; Khan, M.; Aizenberg, J. Research Update: Liquid Gated Membrane Filtration Performance with Inorganic Particle Suspensions. APL Mater. 2018, 6 (100703), 1-10. https://doi.org/10.1063/1.5047480.
(14) Howell, C.; Grinthal, A.; Sunny, S.; Aizenberg, M.; Aizenberg, J.; Howell, P. C. Designing Liquid-Infused Surfaces for Medical Applications: A Review. Adv. Mater. 2018, No. 1802724, 79.
(15) Regan, D. P.; Howell, C. Droplet Manipulation with Bioinspired Liquid-Infused Surfaces: A Review of Recent Progress and Potential for Integrated Detection. Curr. Opin. Colloid Interface Sci. 2019, 39, 137-147. https://doi.org/10.1016/j.cocis.2019.01.012.
(16) Regan, D. P.; Lilly, C.; Weigang, A.; White, L. R.; LeClair, E. J.; Collins, A.; Howell, C. Combining the Geometry of Folded Paper with Liquid-Infused Polymer Surfaces to Concentrate and Localize Bacterial Solutions. Biointerphases 2019, 14 (4), 041005. https://doi.org/10.1116/1.5114804.
(17) AIZENBERG, J.; HOU, X.; KHAN, M.; TESLER, A. FLUID-BASED GATING MECHANISM WITH TUNABLE MULTIPHASE SELECTIVITY AND ANTIFOULING BEHAVIOR. US 2018/0023728 A1, 2018.
(18) Hwang, G. M.; Dicarlo, A. A.; Lin, G. C. An Analysis on the Detection of Biological Contaminants Aboard Aircraft. PLoS One 2011, 6 (1). https://doi.org/10.1371/journal.pone.0014520.
(19) Mangili, A.; Gendreau, M. A. Transmission of Infectious Diseases during Commercial Air Travel. Lancet 2005, 365, 989-996.
(20) Rogers, B. A.; Aminzadeh, Z.; Hayashi, Y.; Paterson, D. L. Country-to-Country Transfer of Patients and the Risk of Multi-Resistant Bacterial Infection. Clin. Infect. Dis. 2011, 53, 49-56.
(21) Verreault, D., Moineau, S. & Duchaine, C. Methods for Sampling of Airborne Viruses. Microbiol. Mol. Biol. Rev. 72, 413-444 (2008). doi:10.1128/mmbr.00002-08.
(22) Wong, T.-S., Kang, S. H., Tang, S. K. Y., Smythe, E. J., Hatton, B. D., Grinthal, A. & Aizenberg, J. Bioinspired self-repairing slippery surfaces with pressure-stable omniphobicity. Nature 477, 443-7 (2011). doi:10.1038/nature10447.
(23) Howell, C., Vu, T. L., Lin, J. J., Kolle, S., Juthani, N., Watson, E., Weaver, J. C., Alvarenga, J. & Aizenberg, J. Self-replenishing vascularized fouling-release surfaces. ACS Appl. Mater. Interfaces 6, 13299-13307 (2014).
(24) Sotiri, I., Overton, J. C., Waterhouse, A. & Howell, C. Immobilized liquid layers: a new approach to anti-adhesion surface for medical applications. Exp. Biol. Med. 241, 909-918 (2016). doi:10.1177/1535370216640942.
(25) Kovalenko, Y., Sotiri, I., Timonen, J. V. I., Overton, J. C., Holmes, G., Aizenberg, J. & Howell, C. Bacterial Interactions with Immobilized Liquid Layers. Adv. Healthc. Mater. 6, 1600948 (2017). doi:10.1002/adhm.201600948.
(26) Aizenberg, J., Aizenberg, M., Kang, S. H., Kim, P. & Wong, T.-S. Slippery Surfaces with High Pressure Stability, Optical Transparency, and Self-Healing Characteristics. (2016).
(27) Aizenberg, J., Hatton, B. D., Ingber, D. E., Super, M. & Wong, T.-S. Slippery Liquid-Infused Porous Surface and Biologial Applications Thereof 2, U.S. Patent Publication No. 2018/0298203 A1 (2018).
(28) Aizenberg, J., Hou, X., Khan, M. & Tesler, A. B. Fluid-Based Gating Mechanism with Tunable Multiphase Selectivity and Antifouling Behavior. 1, U.S. Pat. No. 10,330,218 B2 (2018).
(29) Kreder, M. J., Daniel, D., Tetreault, A., Cao, Z., Lemaire, B., Timonen, J. V. I. & Aizenberg, J. Film dynamics and lubricant depletion by droplets moving on lubricated surfaces. Phys. Fluid Dyn. 1-10 (2018).
(30) Howell, C., Vu, T. L., Johnson, C. P., Hou, X., Ahanotu, O., Alvarenga, J., Leslie, D. C., Uzun, O., Waterhouse, A., Kim, P., Super, M., Aizenberg, M., Ingber, D. E. & Aizenberg, J. Stability of Surface-Immobilized Lubricant Interfaces under Flow. Chem. Mater. 27, 1792-1800 (2015)
(31) Bazyar, H., Javadpour, S. & Lammertink, R. G. H. On the Gating Mechanism of Slippery Liquid Infused Porous Membranes. Adv. Mater. Interfaces (2016). doi:10.1002/admi.201600025.
(32) Sett, S., Yan, X., Barac, G., Bolton, L. & Miljkovic, N. Lubricant-Infused Surfaces for Low Surface Tension Fluids: Promise vs Reality. ACS Appl. Mater. Interfaces 9, 36400-36408 (2017).
(33) Sotiri, I., Tajik, A., Lai, Y., Zhang, C. T., Kovalenko, Y., Nemr, C. R., Ledoux, H., Alvarenga, J., Johnson, E., Patanwala, H. S., Timonen, J. V. I., Hu, Y., Aizenberg, J. & Howell, C. Tunability of liquid-infused silicone materials for biointerfaces. Biointerphases 13, 06D401 (2018).

### EQUIVALENTS

Those skilled in the art will recognize, or be able to ascertain using no more than routine experimentation, many equivalents to the specific embodiments of the invention described herein. The scope of the present invention is not intended to be limited to the above Description, but rather is as set forth in the following claims:

We claim:

1. A method for capturing and retrieving a pathogen/analyte in a fluid sample comprising:
providing a system comprising a substrate/membrane and a chamber;
wherein the substrate/membrane comprises:
(i) an active side and a chamber side; and
(ii) a plurality of pores;
wherein a capture liquid coating is associated with the substrate/membrane;
contacting the substrate/membrane with the fluid sample;
applying pressure to the active side or chamber side of the substrate/membrane so that at least a portion of the fluid sample flows from the active side into and/or through the pores/fibers of the substrate/membrane to the chamber side;
removing the pressure for a period of time to allow the at least a portion of the fluid sample comprising the pathogen/analyte to return to the active side; and
retrieving the pathogen/analyte from the active side of the substrate/membrane.

2. The method of claim 1, wherein applying pressure to the active side or chamber side of the substrate/membrane is or comprises applying a negative pressure to the substrate/membrane.

3. The method of claim 1 or 2, wherein the liquid coating does not fill at least some of the pores.

4. The method of any one of claims 1-3, wherein the pores are or comprise gaps or void space in the substrate/membrane.

5. The method of any one of claims 1-4, wherein the pores are formed from a plurality or set of fibers.

6. The method of any one of claims 1-5, wherein after removing the pressure, additional capture liquid is applied to the substrate/membrane to fill the pores in the substrate/membrane.

7. The method of any one of claims 1-6, wherein the pathogen/analyte is selected from a group consisting of a bacteria, a virus, a toxin, a spore, a chemical, a drug, or a combination thereof.

8. The method of any one of claims 1-7, wherein the pathogen/analyte remains intact when it returns to the active side of the substrate/membrane.

9. The method of any one of claims 1-8, wherein the pathogen/analyte is substantially aerosolized and the fluid sample is or comprises an air sample.

10. The method of any one of claims 1-9, wherein the contacting the substrate/membrane with the fluid sample comprises exposing the substrate/membrane to air on the active side of the substrate/membrane.

11. The method of any one of claims 1-10, wherein the contacting the substrate/membrane with the fluid sample comprises applying (e.g., spraying) the fluid sample on the active side of the substrate/membrane.

12. The method of any one of claims 1-11, wherein the period of time that the negative pressure is removed comprises a period of time within the range of about 1 minute to 1 hour.

13. The method of any one of claims 1-13, wherein collecting the fluid containing the pathogen/analyte comprises one or more physical and/or chemical means.

14. The method of claim 13, wherein the physical means is or comprises pipetting the fluid containing the pathogen/analyte from the active side of the substrate/membrane.

15. The method of any one of claims 1-14, wherein the mean diameter of the pores within the substrate/membrane is within a range of about 0.1 μm to 100 μm.

16. The method of any one of claims 1-15, wherein the membrane/substrate comprises a material selected from: Polytetrafluoroethylene (PTFE), commercial HEPA filters, or paper/cellulose-based material.

17. The method of any one of claims 1-16, wherein the system fits within a housing/cartridge.

18. The method of any one of claims 1-17, wherein the membrane/substrate and/or housing/cartridge is compatible with an air filtration system, a water filtration system, or HVAC system.

19. The method of any one of claims 1-18, wherein the capture liquid comprises a volume that is within the range of 10 μl and 10 ml.

20. The method of any one of claims 1-19, wherein the capture liquid comprises a fluid with a viscosity of between 10-2000 cSt.

21. The method of any one of claims 1-20, where the capture liquid comprises a perfluoropolyether.

22. A system comprising:
a substrate/membrane and a chamber;
wherein the substrate/membrane comprises:
(i) an active side and a chamber side; and
(ii) a plurality of pores;
wherein a capture liquid is associated with the substrate/membrane.

23. The system of claim 22, wherein the capture liquid is applied to the substrate/membrane such that the active side of the substrate/membrane is substantially covered or completely covered.

24. The system of claim 22, wherein the capture liquid is applied to the substrate/membrane such that substantially none of the capture liquid is present within at least some of the pores.

25. The system of claim 22, wherein a portion of the capture liquid is present within at least some of the pores.

26. The system of claim 22, wherein the pores are or comprise gaps or void space in the substrate/membrane.

27. The system of claim 22, wherein the pores are formed from a plurality or set of fibers.

28. The system of any one of claims 22-27, wherein the pathogen/analyte is selected from a group consisting of a bacteria, a virus, a toxin, a spore, a chemical, a drug, or a combination thereof.

29. The system of any one of claims 22-28, wherein the pathogen/analyte is aerosolized and the fluid sample is air sample.

30. The system of any one of claims 22-29, wherein the mean diameter of the pores within the substrate/membrane is within a range of about 0.1 μm to 100 μm.

31. The system of any one of claims 22-30, wherein the membrane/substrate comprises a material selected from: Polytetrafluoroethylene (PTFE), or paper/cellulose-based material.

32. The system of any one of claims 22-31, wherein the system is disposed within a housing/cartridge

33. The system of any one of claims 22-32, wherein the membrane/substrate and/or housing/cartridge is compatible with an air filtration system, a water filtration system, or HVAC system.

34. The system of any one of claims 23-34, wherein the capture liquid comprises a volume that is within the range of 10 μl and 10 ml.

35. The system of any one of claims 23-35, wherein the capture liquid comprises a fluid with a viscosity of between 10-2000 cSt.

36. The system of any one of claims 23-36, where the capture liquid comprises a perfluoropolyether.
